(19) United States
(12) Patent Application Publication
(10) Pub. No.: US 2015/0231811 A1
(43) Pub. Date: Aug. 20, 2015

(54) METHOD FOR PRODUCING SKIN-COVERED FOAMED MOLDED ARTICLE

(71) Applicant: JSP CORPORATION, Tokyo (JP)

(72) Inventors: Tomoo TOKIWA, Kanuma-shi (JP); Hiroki KAWAKAMI, Utsunomiya-shi (JP)

(21) Appl. No.: 14/618,552

(22) Filed: Feb. 10, 2015

(30) Foreign Application Priority Data
Feb. 17, 2014 (JP) 2014-027306

(51) Int. Cl. B29C 49/02

(52) U.S. Cl. CPC B29C 49/02; B29K 2023/06; B29L 2009/00

(57) ABSTRACT

Provided is a method for producing a skin-covered foamed molded article of a hollow molded article in which a molded article of foamed particles is included by forming a hollow molded article by blow molding a parison formed by extruding a melt kneaded product of a polyethylene-based resin, filling thermoplastic resin foamed particles within the hollow molded article, and fusion bonding the foamed particles by supplying and discharging a heating medium from a heating medium supply pins inserted into the hollow molded article, wherein a polyethylene-based resin composition having tensile elongation at break of 500 to 1000% at 80° C. and half-crystallization time of 5 to 50 seconds at 120° C. is used for forming the hollow molded article so that a skin-covered foamed molded article having excellent fusion bonding property between foamed particles can be obtained with a short molding cycle.

### BACKGROUND

1. Technical Field

The present invention relates to a method for producing a skin-covered foamed molded article. Specifically, it relates to a method for producing a skin-covered foamed molded article by filling foamed particles in a hollow part of a hollow molded article obtained by blow molding and performing fusion bonding of the foamed particles by heating, in which a molded article of foamed particles is included in a skin consisting of a hollow molded article.

2. Related Art

A skin-covered foamed molded article obtained by filling foamed particles within a skin material consisting of a hollow molded article and heating the foamed particles by using a heating medium for fusion bonding between the foamed particles is known. For example, in JP 6-166112 A, a method is disclosed in which a parison is formed by extrusion of a polyethylene-based resin, a molding frame is clamped while a plurality of pipes and filling feeder for supplying a heating medium are inserted from an opening at the bottom of the parison, a hollow molded article is formed by blow molding of the parison, foamed particles having a polyethylene-based resin or the like as a base resin are subsequently supplied from a filling feeder and filled in the hollow molded article before complete cooling and solidification of the hollow molded article, and a heating medium like steam is supplied and discharged into and from the hollow molded article from a pipe for supplying and discharging a heating medium inserted into the hollow molded article so that the foamed particles are fusion bonded to each other by heating. Further, in JP 2010-46920 A, a method is disclosed in which a hollow molded article is formed by blow molding of a parison consisting of a polystyrene-based resin in a molding frame, a filling hole is formed by a filling feeder together with inserting, via penetration of a wall part of a hollow molded article, a plurality of pins for supplying and discharging a heating medium from a molding frame side into the hollow molded article before complete cooling and solidification of the hollow molded article, foamed particles of a polystyrene-based resin are supplied from a filling feeder for filling the inside of a hollow molded article, and a heating medium like steam is supplied and discharged from the pins for supplying and discharging a heating medium so that the foamed particles are fusion bonded to each other by heating.

Related documents cited in the specification:

JP 6-166112 A

JP 2010-46920 A

### SUMMARY

The polyethylene-based resin is a resin having higher expandability than a polystyrene-based resin. As such, for forming a hollow molded article to be a skin by using a polyethylene-based resin, if cooling after blow molding is not sufficient, the resin for forming a hollow molded article around the heating medium supply pins are excessively stretched according to insertion of the pin so that a hole is not formed and the heating medium supply pins cannot be pushed and inserted into the hollow molded article. Further, even if the pin can be inserted into the hollow molded article, the opening of the heating medium supply pins are blocked by the stretched resin so that it is difficult to fully supply the heating medium. As a result, the foamed particles within the hollow molded article cannot be fully fusion bonded to each other. For such reasons, when a hollow molded article is formed with a polyethylene-based resin, the pin has to be inserted after further cooling a hollow molded article compared to a case in which the hollow molded article is formed with a polystyrene-based resin, in order to ensure the perforation property (punching property) of a pin at the time of inserting the heating medium supply pins into a hollow molded article. As a result, a longer molding cycle is needed.

An object of the present invention is to provide a method for producing a skin-covered foamed molded article by forming a hollow molded article to be a skin using a polyethylene-based resin and performing heating and fusion bonding of the foamed particles within the skin, the method being capable of obtaining a skin-covered foamed molded article with foamed particles fully fusion bonded to each other by a short molding cycle.

Regarding a method for producing a skin-covered foamed molded article, inventors of the present invention found that, by forming a hollow molded article using a polyethylene-based resin composition which satisfies specific requirements concerning the half-crystallization time and tensile elongation at break under heating, the punching property of a hollow molded article by the heating medium supply pins can be improved. Based on the finding, they conducted intensive studies and completed the present invention accordingly.

Specifically, the gist of the present invention is [1] to [12] that are described below.

[1]A method for producing a skin-covered foamed molded article, comprising the steps of:

extruding a melt of a polyethylene-based resin composition to form a parison in a softened state;
blow-molding the parison into a skin defining a hollow interior space;
inserting heating medium supply pins through the skin;
filling thermoplastic resin foamed particles in the hollow interior space of the skin;
and supplying a heating medium into the skin through the heating medium supply pins to fuse-bond the foamed particles filled in the skin to each other, wherein the polyethylene-based resin composition for forming the hollow molded article has tensile elongation at break of 500 to 1000% at 80° C. and half-crystallization time of 5 to 50 seconds at 120° C.

[2] The method for producing a skin-covered foamed molded article described in above [1], in which the polyethylene-based resin composition has melt elongation of 10 m/minute or more at 230° C.

[3] The method for producing a skin-covered foamed molded article described in above [1], in which the polyethylene-based resin composition is blended with a crystallization promoter including a metal salt compound of alicyclic carboxylic acid or a sorbitol-based compound.

[4] The method for producing a skin-covered foamed molded article described in above [3], in which the blending amount of the crystallization promoter is 0.03 to 0.5 parts by weight relative to 100 parts by weight of the polyethylene-based resin constituting the polyethylene-based resin composition.

[5] The method for producing a skin-covered foamed molded article described in above [3], in which the metal salt compound of alicyclic carboxylic acid is a metal salt of 1,2-cyclohexane dicarboxylic acid.

[6] The method for producing a skin-covered foamed molded article described in above [1], in which the density of the polyethylene-based resin composition is 940 g/L or more.

[7] The method for producing a skin-covered foamed molded article described in above [1], in which the thermoplastic resin foamed particles are foamed particles of a polypropylene-based resin and the foamed particles of a polypropylene-based resin within the skin are heated by supplying heating steam with vapor pressure of 0.15 MPa (G) to 0.6 MPa (G) from the heating medium supply pins.

[8] The method for producing a skin-covered foamed molded article described in above [1], in which the thermoplastic resin foamed particles consist of a core layer of a polypropylene-based resin in a foamed state and a coating layer of a polyethylene-based resin which coats the core layer.

[9] The method for producing a skin-covered foamed molded article described in above [1], in which the average thickness of the skin is 1 to 5 mm.

[10] The method for producing a skin-covered foamed molded article described in above [1], in which the heating medium supply pins are pushed and inserted into the hollow interior space when resin temperature of a hollow molded article for forming the skin is 70 to 100° C.

Meanwhile, in the present invention, the “heating medium supply pins” may be simply referred to as a “pins,” the “hole formed in a hollow molded article by inserting the heating medium supply pin” may be simply referred to as a “pin insertion hole,” and the “hollow molded article for forming the skin” may be simply referred to as a “hollow molded article” or a “skin.”

According to the production method of the present invention, excessive stretching of the resin for forming a hollow molded article does not occur even when the heating medium supply pins are inserted, after molding of the hollow molded article, without cooling the resin temperature of the hollow molded article to a sufficiently low temperature. Rather, the resin for forming the hollow molded article breaks off after being stretched suitably so that the pin is allowed to get inserted into the hollow molded article. For such reasons, the heating medium does not leak from the periphery of the pin insertion hole at the time of supplying a heating medium and the heating medium can be efficiently supplied within the hollow molded article. As such, a skin-covered foamed molded article with an excellent fusion bonding property between foamed particles can be obtained with a short molding cycle.

### BRIEF DESCRIPTION OF DRAWINGS

FIGS. 1A and 1B are schematic partial cross-sectional views illustrating an example of the arrangement state of the heating medium supply pins according to the present invention and the punching state of the hollow molded article; FIG. 1A is a schematic partial cross-sectional view illustrating a state before inserting the pins into the hollow molded article and FIG. 1B is a schematic partial cross-sectional view illustrating a state in which the pins are pushed and inserted into the hollow interior space of the hollow molded article and the resin of the hollow molded article is broken after it has been stretched by following the pin; and

FIG. 2 is an example of a schematic longitudinal-sectional view illustrating the method for producing a skin-covered foamed molded article.

### DETAILED DESCRIPTION

According to the method for producing a skin-covered foamed molded article of the present invention, the method of the present invention is comprised of the following steps:

extruding a melt kneaded product (i.e. a melt) of a polyethylene-based resin composition to form a parison in a softened state;

blow-molding the parison into a skin defining a hollow interior space;

inserting heating medium supply pins through the skin; filling thermoplastic resin foamed particles in the hollow interior space of the skin;

and supplying a heating medium into the skin through the heating medium supply pins to fuse-bond the foamed particles filled in the skin to each other.

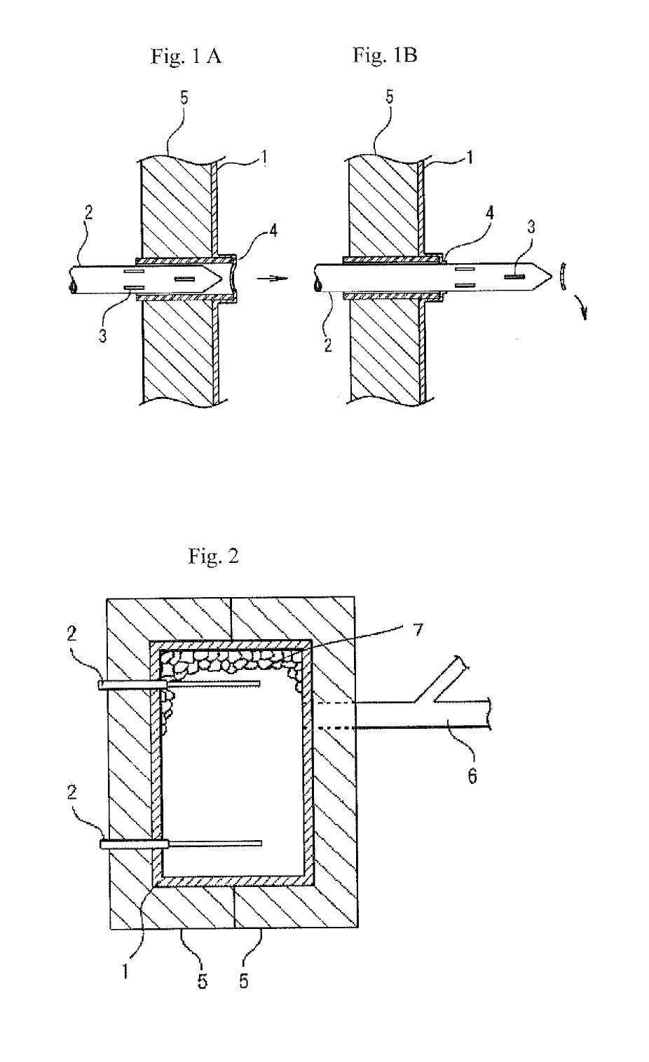

Therefore, according to the present invention, a parison is formed by extruding a melt kneaded product of a polyethylene-based resin, and as illustrated in FIG. 1A, FIG. 1B and FIG. 2, the parison is subjected to blow molding within the blow molding frame 5 while the parison is in a softened state to form a hollow molded article 1, which becomes a skin defining a hollow interior space of a skin-covered foamed molded article. Further, according to the method, foamed particles 7 are subsequently filled, from a feeder 6 for filling foamed particles, in a hollow interior space (i.e. a hollow part) of the hollow molded article 1 and thermal fusion bonding of the foamed particles 7 to each other is performed by supplying a heating medium like steam from a pin 2 for supplying and discharging a heating medium which has been inserted into the hollow molded article 1 via penetration of a wall part of the hollow molded article 1.

The hollow molded article 1 is formed by blow molding of a parison within a molding frame, in which the parison is formed by extruding from a die a melt kneaded product which has been obtained by melt kneading of a polyethylene-based resin in an extruder. After the blow molding, the pin 2 is pushed and inserted through the hollow molded article 1 into the hollow interior space thereof.

As illustrated in FIGS. 1A and 1B, it is preferable that a plurality of openings 3 for supplying and discharging a heating medium with a hole-shape or a slit-shape be formed in the peripheral wall part of the pin 2. It is more preferable that the dimension of the openings 3 for supplying and discharging a heating medium respectively have a diameter of the hole-shape or a width of the slit-shape which is smaller than the particle diameter of the foamed particles 7.

When cooling of the hollow molded article 1 is insufficient at the time of inserting the pin 2, the resin of the hollow molded article 1 near the pin 2 is excessively stretched so that the pin 2 cannot be inserted into the hollow molded article. Alternatively, even when the pin 2 can be pushed and inserted, the opening 3 for supplying and discharging a heating medium, which has been formed in the peripheral wall part of the pin 2, is blocked by the stretched resin so that it may become difficult to supply uniformly a heating medium to the inside of the hollow molded article 1 or it may take time to supply a sufficient amount of a heating medium into the molded article. As a result, there is a possibility that insufficient thermal fusion bonding of the foamed particles 7 filled within the hollow molded article 1 is obtained.

When the pin 2 is pushed and inserted into the hollow molded article 1, it is preferable that the resin near the pin 2 be slightly drawn into the internal side of the hollow molded article 1 and the drawn resin part be formed in a cylindrical pleat-shaped portion. As the cylindrical pleat-shaped portion 4 functions as a seal when a heating medium is supplied from the pin 2, a leak of a heating medium from a space between the peripheral wall part of the pin 2 and a pin insertion hole is effectively prevented. Meanwhile, when the resin of the pin 2 is drawn by following the insertion of the pin 2, the length from the inside of a hollow molded article to the tip of the cylindrical pleat-shaped portion 4 with a corrugation shape may be referred to as resin-following length.

According to the production method of the present invention, the cylindrical pleat-shaped portion 4 with a corrugation shape can be formed more easily. The aforementioned resin-following length is designed in consideration of a thickness or the like of the hollow molded article 1. From the viewpoint of having no leak of a heating medium from the pin insertion hole and also supplying uniformly the heating medium to the inside of the molded article without blocking the opening 3 for supplying and discharging a heating medium of the pin 2, the resin-following length is preferably 1 to 5 mm.

According to the production method of the present invention, the hollow molded article 1 is formed with a polyethylene-based resin composition which has physical properties like tensile elongation at break of 500 to 1.000% at 80° C. and half-crystallization time of 5 to 50 seconds at 120° C. Accordingly, it becomes possible to insert the pin 2 into a hollow molded article in a state allowing uniform supply of a heating medium even when the temperature of the hollow molded article 1 is relatively higher than that of a related art. As a result, it becomes possible to obtain a molded article in which the foamed particles 7 filled in the hollow molded article 1 are fully fusion bonded to each other.

In general, for a case in which the polyethylene-based resin composition does not satisfy the aforementioned physical properties, that is, when the half-crystallization time of the polyethylene-based resin composition is too long at 120° C., the temperature allowing insertion of the pin 2 into the hollow molded article 1 is 70 to 80° C. In this regard, as the resin composition has physical properties satisfying the aforementioned range, insertion of the pin 2 can be achieved in a broader range of the temperature than before, that is, the resin temperature of a hollow molded article is 70° C. to 100° C., which includes a temperature range higher than that of a related art. Further, when the tensile elongation at break at 80° C. is excessively high, insertion of the pin can be made but the resin part drawn by the pin becomes excessively long, and thus the heating medium may not be uniformly supplied. Meanwhile, for a case in which the time for half-crystallization is excessively short or the tensile elongation at break at 80° C. is excessively small even if the time for half-crystallization is appropriate, insertion of the pin 2 itself can be made but there may be leakage of steam due to an occurrence of a space between the pin 2 and the pin insertion hole formed by insertion of the pin 2. Meanwhile, the polyethylene-based resin composition for forming the hollow molded article is a resin composition which is the same as the melt kneaded product of a polyethylene-based resin which has been obtained by melt kneading of the polyethylene-based resin in an extruder.

From this point of view, the time for half-crystallization of the resin composition at 120° C. is preferably 10 to 40 seconds, and the tensile elongation at break at 80° C. of the resin composition is preferably 600 to 900%, and more preferably 700 to 850%. Meanwhile, the tensile elongation at break is measured at temperature of 80° C. because the mold temperature for forming the hollow molded article 1 by blow molding in a mold is generally 80° C.

Further, from the viewpoint of blow molding property of the hollow molded article 1, the melt elongation at 230° C. of the resin composition is preferably 10 m/minute or more, and more preferably 15 to 50 m/minute. As the melt elongation is within the aforementioned range, the hollow molded article 1 with more even thickness can be obtained even when the hollow molded article 1 has a complex shape.

In the present invention, the time for half-crystallization of the polyethylene-based resin composition can be obtained as follows; a resin composition is prepared in a film shape, a support holding the sample in film shape is impregnated in an oil bath kept at 120° C., light transmission which increases in accordance with crystallization of the sample is measured, and the time for half-crystallization is calculated based on Avrami equation. As for a device for measurement, a device for measuring crystallization speed (MK-801) manufactured by Kotaki Shoji Co., Ltd. can be used, for example.

The tensile elongation at break is a value measured under an atmosphere of 80° C. according to JIS K7127 (1999). The tensile elongation at break can be measured by using a measurement device in which Tensilon universal testing machine and an constant temperature reservoir are combined, for example.

The melt elongation is a value measured by capirograph by using an orifice having nozzle diameter of 2.095 mm and length of 8.0 mm. First, an orifice is set inside a cylinder of a capirograph and adjusted to 230° C. Next, to the cylinder adjusted to 230° C., a sample of a required amount (for example, about 20 g) is added and kept for 4 minutes. Then, a melt resin is extruded in a string shape from an orifice with piston rate of 10 mm/minute. The string-shaped product is hang on a pulley with diameter of 45 mm for measuring tension, and then the string-shaped product is collected by using a collecting roller while increasing the collecting rate such that it is increased from 0 m/minute to 200 m/minute over 4 minutes. Further, the collecting rate is increased regularly. When the string-shaped product is broken, the collecting rate right before the breakage is determined as the melt elongation at 230° C. As for a device for measurement, capirograph 1D (cylinder diameter of 9.55 mm, and cylinder length of 350 mm) manufactured by Toyo Seiki Seisaku-Sho, Ltd. can be used, for example.

The average thickness of the hollow molded article 1 is preferably 1 to 10 mm for obtaining excellent balance between light weightiness and strength. The average thickness is particularly preferably 1 to 5 mm. In general, as the average thickness of the hollow molded article 1 becomes smaller, it becomes more difficult to form a good pin insertion hole at the time of inserting the steam pins 2 into the hollow molded article 1. However, according to the production method of the present invention, a good pin insertion hole can be formed even when the average thickness of the hollow molded article 1 is 5 mm or less.

It is preferable that the resin composition for forming the hollow molded article 1 be blended with a crystallization promoter. Examples of the known crystallization promoter include a sorbitol-based compound, a metal salt compound of aliphatic carboxylic acid, a metal salt compound of alicyclic carboxylic acid, an aliphatic carboxylic acid amide compound, a metal salt compound of organic phosphoric acid, and a rosin-based compound. However, for the resin composition to sufficiently satisfy the aforementioned properties, it is preferable that the crystallization promoter contain a metal salt compound of alicyclic carboxylic acid or a sorbitol-based compound as a main component (50% by weight or more). More preferably, it contains a metal salt compound of alicyclic carboxylic acid as a main component. Particularly preferred examples of the metal salt compound of alicyclic carboxylic acid include a metal salt of 1,2-cyclohexane dicarboxylic acid. Preferred examples of the sorbitol-based compound include bis(methylbenzylidene)sorbitol-based compound. A crystallization promoter containing a metal salt compound of alicyclic carboxylic acid is commercially available under the trade name of “Hyperform” series or the like manufactured by Milliken Chemical Company. It is also commercially available in a master batch type under the trade names of “Rikemaster CN” series manufactured by Riken Vitamin Co., Ltd., “HL3-4” manufactured by Milliken Chemical Company, or the like. A crystallization promoter containing a sorbitol-based compound is commercially available under the trade name of “Gel All MD” or the like manufactured by New Japan Chemical Co., Ltd.

The blending amount of the crystallization promoter may vary depending on the type and property of a polyethylene-based resin. However, relative to 100 parts by weight of the polyethylene-based resin for forming the hollow molded article 1, the blending amount of the crystallization promoter is preferably 0.01 to 1 part by weight, more preferably 0.02 to 0.7 parts by weight, and even more preferably 0.03 to 0.5 parts by weight. When the crystallization promoter is within the aforementioned range, crystallization of the polyethylene-based resin composition for forming a hollow molded article occurs rapidly and specific tensile elongation at break is shown at 80° C. Thus, it is preferable from the viewpoint of enabling formation of favorable pin insertion hole.

As described herein, the polyethylene-based resin means that a structural unit of an ethylene component is preferably present at 50% by mol or more in the resin. More preferably, a structural unit of an ethylene component is preferably present at 60% by mol or more. Even more preferably, it is present 80% by mol or more. Examples of the polyethylene-based resin include high density polyethylene, linear type low density polyethylene, low density polyethylene, ultra-low density polyethylene, and an ethylene-vinyl acetate copolymer. They may be used either singly or in combination of two or more types.

In order for the polyethylene-based resin composition to fully satisfy the aforementioned properties, high density polyethylene is preferable. In particular, polyethylene with density of 940 g/L or more is preferable. Polyethylene with density of 945 to 970 g/L is more preferable.

From the viewpoint of a blow molding property, a polyethylene-based resin having melt flow rate (MFR) of 0.01 to 10 g/10 minutes is preferably used. Meanwhile, measurement of the melt flow rate (MFR) for the polyethylene-based resin is performed based on the test condition D (temperature of 190° C., and a load of 2.16 kg) of JIS K7210 (1999).

If necessary, the polyethylene-based resin for forming the hollow molded article 1 may be added with various additives in addition to the crystallization promoter described above. Examples of the additives include an electrical conductivity imparting agent, an anti-oxidant, a thermal stabilizer, an anti-weathering agent, a UV protecting agent, a flame retardant, an inorganic filler, an anti-bacterial agent, an agent for shielding electromagnetic wave, a gas blocking agent, and an anti-static agent. The additives are added within a range in which the purpose and effect are exhibited. The addition amount is, relative to 100 parts by weight of the polyethylene-based resin, generally 10 parts by weight or less, preferably 5 parts by weight or less, and more preferably 3 parts by weight or less.

According to the present invention, the polyethylene-based resin composition for forming the hollow molded article 1 has a time for half-crystallization and tensile elongation at break both in a specific range, and thus insertion of the pin 2 can be made in a good state even when the resin temperature of the hollow molded article 1 is high. Further, according to the production method of the present invention, because the tensile elongation at break under heating is in a specific range as described above, suitable following of the resin of the hollow molded article 1 can be achieved at the time of inserting the pin 2. Accordingly, poor punching by the pin 2 or steam leakage is prevented so that a molded article having foamed particles sufficiently fusion bonded to each other can be obtained.

Namely, according to the production method of the present invention, as the resin composition for forming the hollow molded article 1 has a time for half-crystallization and tensile elongation at break both in the specific ranges described above, the molding cycle is shortened and also a favorable molded article having foamed particles excellent in being fusion bonded to each other can be obtained.

The foamed particles 7 used in the present invention are preferably foamed particles of a polypropylene-based resin. Because the polypropylene-based resin has excellent heat resistance, by having foamed particles of a polypropylene-based resin, it is unlikely that the air bubble structure of the foamed particles of the hollow molded article 1 is disrupted by heat, and therefore a molded article having the same dimension as the mold can be obtained.

Further, considering the advantages described above and a binding property between a skin consisting of the hollow molded article 1 and a molded article of foamed particles, the foamed particle 7 used in the present invention is preferably a foamed particle having a so-called sheath and core structure consisting of a polypropylene-based resin core layer in foamed state and a polyethylene-based resin coating layer which coats the core layer. Further, when a coating layer is formed with a polyethylene-based resin obtained by polymerization using a metallocene-based polymerization catalyst, a binding property between a core layer and a coating layer is improved, and therefore more preferable.

In the present invention, the apparent density of the foamed particles is not particularly limited. However, foamed particles with apparent density of 0.015 to 0.3 g/cm³ are preferably used. Furthermore, from the viewpoint of having easy control of the secondary foaming property of foamed particles by a heating medium, the apparent density of the foamed particles is more preferably 0.02 to 0.15 g/cm³.

The foamed particles can be produced by a method known for producing foamed particles of those types. For example, resin particles are dispersed in a dispersion medium (generally, water) in a required amount in a sealed vessel like an autoclave which can be pressurized, a foaming agent is added under pressure to impregnate it in resin particles under heating, and after a certain period of time, foamable resin particles containing a foaming agent are discharged and foamed together with a dispersion medium from the vessel at high temperature and high pressure conditions to a low pressure range (generally, atmospheric pressure) to yield foamed particles.

The method for producing a skin-covered foamed molded article of the present invention is specifically described as follows. A parison in a softened state which has been extruded from an extruder is subjected to blow molding. Accordingly, the hollow molded article 1 having a shape reflecting the shape of a molding frame due to a contact between the external surface of the parison and the internal surface of a cavity of the molding frame is molded.

For blow molding, when the hollow molded article 1 is molded after lowering the pressure of a space between the external surface of the parison and the internal surface of a cavity of the molding frame, a shape reflecting the shape of the cavity of the molding frame can be easily obtained, and therefore desirable.

According to the present invention, as for the gas (blow air) to be blown into a parison for blow molding of a parison in a softened state, pressurized gas with parison introduction pressure of 0.5 MPa (G) is injected although it may vary depending on desired shape of a molded article, fluidity of a parison resin or the like. Further, the temperature condition of a mold is preferably 70 to 80° C.

According to the present invention, the foamed particles 7 are filled in a hollow part of the hollow molded article 1 from the feeder 6 for filling foamed particles, and a heating medium is supplied from the openings 3 for supplying and discharging a heating medium which has been formed in the pin 2 inserted into the hollow part of the hollow molded article 1, and thus thermal fusion bonding of the foamed particles 7 is achieved. When steam is used as a heating medium, vapor pressure of the heating steam supplied to the hollow molded article 1 is preferably 0.15 MPa to 0.6 MPa (G). It is more preferably 0.18 MPa to 0.5 MPa (G).

With regard to the structure of the pin 2, a tubular body having an empty inside and a closed tip part is generally preferable. Shape of the tip part of the pin 2 is not particularly limited if it can punch the hollow molded article 1. Examples of the shape of the tip part include a concave shape, a convex shape with sharp protrusion, and a flat shape.

According to the production method of the present invention, the pin 2 to be inserted into a hollow part of the hollow molded article 1 can be generally used not only for supplying a heating medium but also for discharging a heating medium, and a plurality of the pins 2 are inserted. As for the number of the pins 2 and a distance therebetween, it is sufficient to have those allowing supply of a heating medium required for sufficient fusion bonding of the foamed particles. As for the method for heating, it is possible to adopt any method such as a one way heating method in which a part of a plurality of the pins 2 is fixed on a heating medium supply side and the remaining part is fixed on a heating medium discharge side and heating is performed only from one direction or an alternate heating method in which heating is first performed by using a heating medium after a part of a plurality of the pins 2 is set as a supply side and the remaining part is set as a discharge side and heating is further performed by replacing the pin 2 on the supply side and the discharge side. However, for more strong fusion bonding between foamed particles, the alternate heating method is preferable.

### EXAMPLES

Hereinbelow, the present invention is described in view of the examples but the present invention is not limited thereto.

The polyethylene-based resin and crystallization promoters which have been used in the Examples and the Comparative Examples are described in Table 1 and Table 2, respectively.

TABLE 1

| | | | Manufacturer | Density | MFR |
|---|---|---|---|---|---|
| Abbreviation | Type | Grade | — | g/L | g/10 min |
| PE1 | High | Nipolon | TOSOH | 950 | 0.10 |
| | density | Hard | CORPO- | | |
| | polyeth- | 6530 | RATION | | |
| | ylene | | | | |

TABLE 2

| Abbrevi- | Product | Manufac- | |
|---|---|---|---|
| ation | name | turer | Compound name |
| AD1 | HYPERFORM | Milliken | Zinc stearate/1,2-Cyclohexane |
| | HPN-20E | Chemical | diocarboxylic Acid, Calcium |
| | | | salt = 34/66 wt % |
| AD2 | RIKEMASTER | Riken | Master batch of AD1 (base |
| | CN-002 | Vitamin | resin HDPE, concentration of |
| | | Co., Ltd. | 4% by weight) |
| AD3 | RIKEMASTER | Riken | Master batch of AD1 (base |
| | CN-001 | Vitamin | resin LDPE, concentration of |
| | | Co., Ltd. | 4% by weight) |
| AD4 | NJSTAR | New Japan | N,N′-Dicyclohexyl-2,6- |
| | NU-100 | Chemical | naphthalene dicarboxamide |
| | | Co., Ltd. | |
| AD5 | ADK STAB | ADEKA | phosphate ester (ester of 2- |
| | NA-27 | Corporation | hydroxy-2-oxo-4,6,10,12- |
| | | | tetra-t-butyl-1,3,2-dibenzo |
| | | | [d,g]perhydrodioxaphosphocin |
| | | | sodium salt) |
| AD6 | GEL ALL | New Japan | 1,3:2,4-bis-O-(4-methyl- |
| | MD | Chemical | benzylidene)-D-sorbitol |
| | | Co., Ltd. | |

Each physical property of the Examples and the Comparative Examples was measured and evaluated as described below.

### [Tensile Elongation at Break]

The measurement was made according to JIS K7127 (1999) by using a measurement device in which Tensilon universal testing machine manufactured by ORIENTEC Co., LTD. and an incubator for tensile tester manufactured by Toyo Baldwin Co., Ltd. were combined. Specifically, a part of the hollow molded article was pressed to have a thickness of 0.27 mm by heat press (press temperature of 220° C.), the five test specimens were prepared from the pressed product, and after keeping them for 60 seconds in an incubator maintained at 80° C., the measurement was made with conditions including inter-gripper distance of 25 mm and elongation rate of 500 mm/min. The obtained value was used a tensile elongation at break.

### [Time for Half-Crystallization]

The test specimen cut from the hollow molded article was prepared as a film by heat press (press temperature of 220° C.) to yield a sample. In that case, the thickness of film-like sample was 0.1±0.02 mm and it has a rectangular shape with the size of 15×15 mm. It was then placed on a cover glass for microscope and used as a sample for measurement. The time for half-crystallization was measured as follows. The cover glass holding the film-like sample was placed and fully melted in an air bath of a device for measuring crystallization rate (MK-801 manufactured by Kotaki Shoji Co., Ltd.). Then, the melt sample on the support itself was placed between orthogonal polarizing plates in an oil bath which has been maintained at 120° C., and the light transmission caused by optically anisotropic crystallization component, which increases in accordance with sample crystallization, was measured (depolarization method). Then, by using Avrami equation shown below, the time for half-crystallization was calculated from the time at which the crystallization degree is reduced to ½.

$$1 - Xc = Exp ( - {kt}^{n} ) = ( It - Ig ) / ( I 0 - Ig ) \qquad ( Mathematical formula 1 )$$

(with the proviso that, Xc: crystallization degree, k: crystallization speed constant, n: Avrami constant, t: time (second), I0: depolarization transmission intensity [start point], It: depolarization transmission intensity [after t seconds], Ig; depolarization transmission intensity [end point])

### [Skin Thickness]

The obtained skin-covered foamed molded article was cut, at three points in total, vertically relative to the longitudinal direction. The measurement was made for the skin part at six points that were apart at the same distance from each other in the peripheral direction of each cross-section. Then, the arithmetic average value of the thickness obtained from the 18 points was determined as skin thickness (average thickness of a hollow molded article).

### [Apparent Density of Foamed Particles]

By using a wire mesh, a group of foamed particles with weight of W (g) was settled on a bottom of a measuring cylinder with water added therein. Then, by reading the increased water level, volume V (L) of the group of foamed particles was obtained. Then, the weight W of the group of the foamed particles was divided by the volume V to obtain W/V with unit conversion into [kg/m³].

### [Time Until Insertion of Steam Pins, Temperature for Pins Insertion]

The time until insertion of steam pins were determined as a time from the completion of clamping a mold to start of insertion of steam pins. The temperature at the time of inserting the steam pins were determined as a temperature for pin insertion.

### [Fusion Bonding Property Between Foamed Particles and Skin]

As a test specimen for evaluating the fusion bonding property, total five test specimens of a 100 mm×100 mm×thickness of a skin-covered foamed molded article were cut at five points in total from a center region and four corner regions (excluding R part) of a plate-like skin-covered foamed molded article which has been molded before, in which the cut was made to include the skin. Then, the top and bottom surfaces of the test specimen were firmly fixed by using adhesives on a jig for measuring the binding strength. Then, the skin peeling test was performed for each test specimen using a tensile strength tester Tensilon at elongation rate of 10 mm/minute. All foamed particles on a peeling surface were observed with a naked eye to determine the state of the particles on a peeling surface and the number of the broken foamed particles and the number of the foamed particles that were peeled from an interface between the foamed particles and the skin were counted. The ratio of the number of the broken foamed particles compared to the total of the number of the broken foamed particles and the number of the foamed particles that were peeled from an interface with the skin was obtained. The smallest value among the values obtained from the five test specimens was determined as the fusion bonding rate between the foamed particles and the skin, and it was evaluated according to the following evaluation criteria.

◯: Fusion bonding rate between the skin and foamed particles was 50% or higher.

X: Fusion bonding rate between the skin and foamed particles was less than 50%.

### [Fusion Bonding Property Between Foamed Particles]

As a test specimen for evaluating the fusion bonding property, total five test specimens of a 100 mm×100 mm×thickness excluding a skin were cut at five points in total from a center region and four corner regions (excluding R part) of a plate-like skin-covered foamed molded article which has been molded before, in which the cut was made not to include the skin. By using a cutter knife, a cut mark of about 3 mm was made in thickness direction of the test specimen, and the test specimen was broken along the cut mark. All foamed particles on a broken surface were observed with a naked eye to determine the state of the particles on a broken surface and the number of the broken foamed particles and the number of the foamed particles that were peeled from an interface between the foamed particles were counted. The ratio of the number of the broken foamed particles compared to the total of the number of the broken foamed particles and the number of the foamed particles that were peeled from an interface between the foamed particles was obtained. The smallest value among the values obtained from the five test specimens was determined as the fusion bonding rate of the foamed particles, and it was evaluated according to the following evaluation criteria.

◯: Fusion bonding rate of the foamed particles was 50% or higher.

X: Fusion bonding rate of the foamed particles was less than 50%.

### [Formation State of Steam Pin Insertion Hole]

Based on the length of the resin of a hollow molded article drawn by the steam pins at the time of inserting the steam pins into a hollow molded article, the determination was made as follows.

◯: It was possible to have steam pins insertion and the lengths of the resin part drawn by the steam pins were in the range of 1 mm to 5 mm.

X¹: It was possible to have steam pins insertion but the lengths of the resin part drawn by the steam pins were more than 5 mm.

X²: It was possible to have steam pins insertion but the lengths of the resin part drawn by the steam pins were less than 1 mm.

XX: There was a point at which the steam pins insertion cannot be made.

### [Molding Time for Whole Process]

The time (seconds) required from starting clamping of a frame for molding a hollow molded article to finishing the molding and recovering a skin-covered foamed molded article from a mold was set as a molding time for whole process.

### Example 1

To an extruder having inner diameter of 65 mm, the polyethylene-based resin shown in Table 1 and the crystallization promoter shown in Table 2 were supplied to have the blending shown in Table 3. By heating and kneading them at 210° C., a melt product of the resin composition was prepared. Next, the melt product of the resin composition was filled in an accumulator which has been attached to an extruder and adjusted to 210° C. Subsequently, the melt product of the resin composition was extruded from a die to form a parison in a softened state. After clamping a split type mold for blow molding which has a mold cavity with cuboid shape of height 730 mm×width 420 mm×thickness 30 mm, being placed right below the die, the parison was inserted into the mold. Meanwhile, the mold temperature was set at 80° C. After that, the blow pins were inserted into the parison and the parison was subjected to blow molding by reducing the pressure of a space between an external surface of the parison and an inner surface of a mold while pressurized air of 0.50 MPa (G) was simultaneously blown from the blow pins to the inside of the parison. As a result, a hollow molded article having a shape reflecting the shape of the mold cavity was formed.

Thirty seconds after completing the clamping, a steam pin having a slit-like inlet for steam supply on a lateral side (opening diameter of 8 mmφ) was inserted into the hollow molded article at eight points (2 rows×4 columns, pitch of 200 mm) in the same interval, that is, from one mold of the aforementioned molds to thickness direction of a product (protrusion length from the mold; 25 mm), and also a feeder (opening diameter of 18 mmφ) for filling foamed particles was inserted into the hollow molded article. After completing the insertion, the foamed particles of a polypropylene-based resin with apparent density of 0.055 g/cm³ were filled from a feeder for filling foamed particles to a hollow part of the hollow molded article while performing gas discharge from the steam pins. Meanwhile, as the foamed particles of a polypropylene-based resin, foamed particles having a core and sheath structure consisting of a core layer in foamed state which had been formed of a polypropylene-based resin (ethylene-propylene random copolymer polymerized by using a Ziegler Natta-based polymerization catalyst, ethylene content of 2.8% by weight and melting point of 143° C.) and a coating layer which had been formed of a polyethylene-based resin (low density linear type polyethylene polymerized by using a metallocene polymerization catalyst, density of 0.906 g/cm³ and melting point of 102° C.) were used (weight of core layer/weight of sheath layer=95/5).

After filling the foamed particles in a hollow part of the hollow molded article, steam of 0.32 MPa (G) was supplied for 8 seconds from steam pins while steam was aspirated off from the steam pins on the other side which had been inserted into the hollow molded article. Next, while performing aspiration from the steam pins used for steam supply, steam of 0.32 MPa (G) was supplied for 8 seconds from the other steam pins used for steam aspiration. After that, steam of 0.32 MPa (G) was supplied for 8 seconds from all steam pins for thermal fusion bonding of the foamed particles to each other. After cooling the mold, the mold was open and a desired skin-covered foamed molded article was obtained. The time until insertion of the steam pins into a hollow molded article after closing the mold for blow molding, the temperature of a hollow molded article at the time of steam pin insertion, the formation state of a steam pin insertion hole (perforation property), the fusion bonding property between foamed particles, and the mold time for whole process are described in Table 4.

### Example 2

A hollow molded article was molded in the same manner as Example 1 except that the time for half-crystallization of the resin composition at 120° C. was adjusted to 27 seconds and the tensile elongation at break at 80° C. was adjusted to 760%.

### Example 3

A hollow molded article was molded in the same manner as Example 1 except that the time for half-crystallization of the resin composition at 120° C. was adjusted to 31 seconds, the tensile elongation at break at 80° C. was adjusted to 800%, and the steam pins were inserted into the hollow molded article 50 seconds after completing the clamping of the frame.

### Example 4

A hollow molded article was molded in the same manner as Example 1 except that the time for half-crystallization of the resin composition at 120° C. was adjusted to 30 seconds, the tensile elongation at break at 80° C. was adjusted to 800%, and the steam pins were inserted into the hollow molded article 35 seconds after completing the clamping of the frame.

### Example 5

A hollow molded article was molded in the same manner as Example 1 except that the time for half-crystallization of the resin composition at 120° C. was adjusted to 30 seconds, the tensile elongation at break at 80° C. was adjusted to 730%, and the steam pins were inserted into the hollow molded article 35 seconds after completing the clamping of the frame.

### Example 6

A hollow molded article was molded in the same manner as Example 1 except that the time for half-crystallization of the resin composition at 120° C. was adjusted to 40 seconds, the tensile elongation at break at 80° C. was adjusted to 750%, and the steam pins were inserted into the hollow molded article 50 seconds after completing the clamping of the frame.

### Comparative Example 1

A hollow molded article was molded according to the Examples while, as a resin composition, a composition with the time for half-crystallization at 120° C. of 75 seconds and the tensile elongation at break at 80° C. of at least 1200% was used. However, when the cooling time until insertion of the steam pins were 50 seconds, it was impossible to perform steam pins insertion. Thus, to form a good hole for steam insertion, it was necessary to have 90 seconds of the cooling time until insertion of the steam pins.

### Comparative Example 2

A hollow molded article was molded according to the Examples while, as a resin composition, a composition with the time for half-crystallization at 120° C. of 56 seconds and the tensile elongation at break at 80° C. of at least 1200% was used. However, when the steam pins were inserted into the hollow molded article 50 seconds after completing the clamping of the frame, it was impossible to form a hole for steam pin insertion.

### Comparative Example 3

A hollow molded article was molded according to the Examples while, as a resin composition, a composition with the time for half-crystallization at 120° C. of 40 seconds and the tensile elongation at break at 80° C. of at least 1200% was used. However, even when the time for half-crystallization was 40 seconds, the tensile elongation at break was at least 1200%, and thus when the steam pins were inserted into the hollow molded article 50 seconds after completing the frame clamping, most of the openings for supplying steam present on a lateral side of the stem pins were covered by the stretched resin of the hollow molded article. As a result, it was impossible to have firm fusion bonding between foamed particles.

### Comparative Example 4

A hollow molded article was molded according to the Examples while, as a resin composition, a composition with the time for half-crystallization at 120° C. of 29 seconds and the tensile elongation at break at 80° C. of 440% was used. However, even when the time for half-crystallization was 29 seconds, the tensile elongation at break was 440%, and thus the steam pins can be inserted into the hollow molded article 50 seconds after completing the frame clamping. However, the lengths of the resin part drawn by the steam pins were less than 1 mm, and thus supplied steam has leaked from the hole for steam pin insertion. As a result, it was impossible to have firm fusion bonding between foamed particles.

TABLE 3

| | | | | | half-crystal- | Tensile elong- | Melt |
|---|---|---|---|---|---|---|---|
| | Polyethylene-based resin | | Crystallization promoter | | lization time | ation at break | elongation |
| | Abbreviation | Blending amount | Abbreviation | Blending amount * | at 120° C. | at 80° C. | at 230° C. |
| | — | Parts by weight | — | Parts by weight | Second | % | m/min |
| Example 1 | PE1 | 100 | AD1 | 0.1 | 29 | 780 | 31 |
| Example 2 | PE1 | 100 | AD2 | 0.1 | 27 | 760 | 30 |
| Example 3 | PE1 | 100 | AD2 | 0.04 | 31 | 800 | 27 |
| Example 4 | PEl | 100 | AD3 | 0.1 | 30 | 800 | 32 |
| Example 5 | PE1 | 100 | AD6 | 0.3 | 30 | 730 | 33 |
| Example 6 | PE1 | 100 | AD6 | 0.15 | 40 | 750 | 33 |
| Comparative | PE1 | 100 | None | — | 75 | >1200 | 25 |
| Example 1 | | | | | | | |
| Comparative | PE1 | 100 | AD4 | 0.4 | 56 | >1200 | 25 |
| Example 2 | | | | | | | |
| Comparative | PE1 | 100 | AD4 | 1.0 | 40 | >1200 | 25 |
| Example 3 | | | | | | | |
| Comparative | PE1 | 100 | AD5 | 0.6 | 29 | 440 | 8 |
| Example 4 | | | | | | | |

* In case of blending a crystallization promoter in master batch form, it indicates a blending amount as a crystallization promoter

TABLE 4

| | Conditions for production | | | | | | |
|---|---|---|---|---|---|---|---|
| | | Steam pin | | Evaluation | | | |
| | | | Temperature of hollow | Formation state | Fusion bonding property | | |
| | Skin | Time until | molded article at the | of hole for steam | Between skin and | Between | Molding time for |
| | Thickness | insertion | time of insertion | pin insertion | foamed particles | foamed particles | whole process |
| | mm | Second | ° C. | — | — | — | Second |
| Example 1 | 2.5 | 30 | 95 | ◯ | ◯ | ◯ | 250 |
| Example 2 | 2.5 | 30 | 95 | ◯ | ◯ | ◯ | 250 |
| Example 3 | 2.5 | 50 | 85 | ◯ | ◯ | ◯ | 270 |
| Example 4 | 2.5 | 35 | 90 | ◯ | ◯ | ◯ | 255 |
| Example 5 | 2.5 | 35 | 90 | ◯ | ◯ | ◯ | 255 |
| Example 6 | 2.5 | 50 | 85 | ◯ | ◯ | ◯ | 270 |
| Comparative | 2.5 | 50 | 85 | XX | X | X | — |
| Exmple 1 | | 90 | 75 | ◯ | ◯ | ◯ | 310 |
| Comparative | 2.5 | 50 | 85 | XX | X | X | — |
| Example 2 | | | | | | | |
| Comparative | 2.5 | 50 | 85 | X¹ | X | X | — |
| Example 3 | | | | | | | |
| Comparative | 2.5 | 50 | 85 | X² | X | X | — |
| Example 4 | | | | | | | |

What is claimed is:

1. A method for producing a skin-covered foamed molded article, comprising the steps of:
extruding a melt of a polyethylene-based resin composition to form a parison in a softened state;
blow-molding the parison into a skin defining a hollow interior space;
inserting heating medium supply pins through the skin;
filling thermoplastic resin foamed particles in the hollow interior space of the skin;
and supplying a heating medium into the skin through the heating medium supply pins to fuse-bond the foamed particles filled in the skin to each other, wherein
the polyethylene-based resin composition for forming the hollow molded article has tensile elongation at break of 500 to 1000% at 80° C. and half-crystallization time of 5 to 50 seconds at 120° C.

2. The method for producing a skin-covered foamed molded article according to claim 1, wherein the polyethylene-based resin composition has melt elongation of 10 m/minute or more at 230° C.

3. The method for producing a skin-covered foamed molded article according to claim 1, wherein the polyethylene-based resin composition is blended with a crystallization promoter including a metal salt compound of alicyclic carboxylic acid or a sorbitol-based compound.

4. The method for producing a skin-covered foamed molded article according to claim 3, wherein a blending amount of the crystallization promoter is 0.03 to 0.5 parts by weight relative to 100 parts by weight of the polyethylene-based resin constituting the polyethylene-based resin composition.

5. The method for producing a skin-covered foamed molded article according to claim 3, wherein the metal salt compound of alicyclic carboxylic acid is a metal salt of 1,2-cyclohexane dicarboxylic acid.

6. The method for producing a skin-covered foamed molded article according to claim 1, wherein density of the polyethylene-based resin composition is 940 g/L or more.

7. The method for producing a skin-covered foamed molded article according to claim 1, wherein the thermoplastic resin foamed particles are foamed particles of a polypropylene-based resin and the foamed particles of a polypropylene-based resin within the skin are heated by supplying heating steam with vapor pressure of 0.15 MPa (G) to 0.6 MPa (G) from the heating medium supply pins.

8. The method for producing a skin-covered foamed molded article according to claim 1, wherein the thermoplastic resin foamed particles comprise a core layer of a polypropylene-based resin in a foamed state and a coating layer of a polyethylene-based resin which coats the core layer.

9. The method for producing a skin-covered foamed molded article according to claim 1, wherein an average thickness of the skin is 1 to 5 mm.

10. The method for producing a skin-covered foamed molded article according to claim 1, wherein the heating medium supply pins are pushed and inserted into the hollow interior space when resin temperature of a hollow molded article for forming the skin is 70 to 100° C.
